(19) United States
(12) Patent Application Publication
(10) Pub. No.: US 2011/0136479 A1
(43) Pub. Date: Jun. 9, 2011

(54) MOBILE TERMINAL AND METHOD OF CONTROLLING THE SAME

(76) Inventors: Mi Jeong KIM, Seoul (KR); Eun Kyu Chang, Seoul (KR); Jung Hoan Kim, Seoul (KR)

(21) Appl. No.: 12/639,954

(22) Filed: Dec. 16, 2009

(30) Foreign Application Priority Data
Dec. 4, 2009 (KR) 10-2009-0119896

(51) Int. Cl. H04M 3/00; H04M 1/00; G05B 19/02

(52) U.S. Cl. 455/418; 455/550.1

(57) ABSTRACT

A mobile terminal that controls the output of an audio based on contact or approach of an external object and a method of controlling the mobile terminal, are discussed. According to an embodiment, the mobile terminal includes an audio output module configured to output an audio; a sensing unit arranged to sense an object approaching the audio output module; and a controller configured to stop the outputting of the audio, when the sensing unit senses the object approaching the audio output module while the audio is being output through the audio output module.

This nonprovisional application claims priority under 35 U.S.C. §119(a) on Patent Application No. 10-2009-0119896 filed in Republic of Korea on Dec. 4, 2009 the entire contents of which are hereby incorporated by reference.

### BACKGROUND

1. Field

This document relates to a mobile terminal that controls the output of an audio based on contact or approach of an external object and a method of controlling the mobile terminal.

2. Related Art

As mobile terminal having functions of replaying multimedia contents are prevalent, various user interfaces are necessary to be able to effectively control replay and output of the multimedia contents.

### SUMMARY

A first aspect of this document is to provide a mobile terminal including: an audio output module; a sensing unit arranged to sense an object approaching the audio output module; and a controller configured to stop outputting the audio when sensing the object approaching the audio output module through the sensing unit while outputting the audio through the audio output module.

A second aspect of this document is to provide a mobile terminal including: an audio output module; a sensing unit arranged to sense an object approaching the audio output module; and a controller configured to sequentially output a first sound source and a second sound source through the audio output module and stop outputting the second output source when sensing the object approaching the audio output module through the sensing unit while the first and second sound sources are outputted.

A third aspect of this document is to provide a mobile terminal including: an audio output module; a proximity sensor arranged to sense an object approaching the audio output module; and a controller configured to control an output characteristic of an audio depending on a degree of the object approaching the audio output module when sensing the object approaching the audio output module through the proximity sensor while outputting the audio through the audio output module.

A fourth aspect of this document is to provide a method of controlling a mobile terminal, including: outputting an audio through an audio output module; and stopping outputting the audio upon sensing an object approaching the audio output module.

A fifth aspect of this document is to provide a method of controlling a mobile terminal including: sequentially outputting a plurality of different sound sources through an audio output module; and stopping outputting at least one outputted latest among the plurality of different sound sources when an object approaching the audio output module is sensed while the plurality of sound sources are outputted.

A sixth aspect of this document is to provide a method of controlling a mobile terminal including: outputting an audio through an audio output module; sensing an object approaching the audio output module; and controlling an output characteristic of the audio depending on a degree of the object approaching the audio output module.

The mobile terminal and the method of controlling the mobile terminal according to an embodiment allow an audio output to be controlled in various methods according to contact or approach of an external object, so that an audio output status desired by a user may be swiftly and effectively accomplished.

A mobile terminal and method of controlling the mobile terminal according to various embodiments of the invention address the limitations and disadvantages associated with the related art.

According to another aspect, the invention provides a mobile terminal comprising: an audio output module configured to output an audio; a sensing unit arranged to sense an object approaching the audio output module; and a controller configured to stop the outputting of the audio, when the sensing unit senses the object approaching the audio output module while the audio is being output through the audio output module.

According to another aspect, the invention provides a mobile terminal comprising: an audio output module configured to output an audio; a sensing unit arranged to sense an object approaching the audio output module; and a controller configured to output a first sound source and a second sound source through the audio output module, and stop the outputting of at least one of the first and second output sources when the sensing unit senses the object approaching the audio output module while the first and second sound sources are being output through the audio output module simultaneously.

According to another aspect, the invention provides a mobile terminal comprising: an audio output module configured to output an audio; a proximity sensor arranged to sense an object approaching the audio output module; and a controller configured to control an output characteristic of the audio being output depending on an approach degree of the object approaching the audio output module, when the proximity sensor senses the object approaching the audio output module while the audio is being output through the audio output module.

According to another aspect, the invention provides a method of controlling a mobile terminal including an audio output module, the method comprising: outputting an audio through the audio output module; and stopping the outputting of the audio upon sensing an object approaching the audio output module.

According to another aspect, the invention provides a method of controlling a mobile terminal including an audio output module, the method comprising: outputting a plurality of different sound sources through the audio output module; and stopping the outputting of at least one of the plurality of different sound sources, when an object approaching the audio output module is sensed while the plurality of sound sources are being output simultaneously.

According to another aspect, the invention provides a method of controlling a mobile terminal including an audio output module, the method comprising: outputting an audio through the audio output module; sensing an object approaching the audio output module; and controlling an output characteristic of the audio being output depending on an approach degree of the object approaching the audio output module.

### BRIEF DESCRIPTION OF THE DRAWINGS

The implementation of this document will be described in detail with reference to the following drawings in which like numerals refer to like elements.

FIG. 1 is a block diagram of a mobile terminal according to an embodiment of the invention.

FIG. 2 is a front perspective view of a mobile terminal or a handheld terminal according to an embodiment of the invention.

FIG. 3 is a rear perspective view of the handheld terminal shown in FIG. 2.

FIGS. 4 and 5 are views illustrating sensing an object approaching the audio output module 152 by using the touch screen 151 according to an embodiment of the invention.

FIGS. 6 to 8 are views illustrating examples of the proximity sensor 141 that are arranged at a location corresponding to the audio output module 152 according to an embodiment of the invention.

FIG. 9 is a conceptual diagram used for explaining a proximity depth of the proximity sensor 141 according to an embodiment of the invention.

FIG. 10 is a flowchart illustrating a method of controlling a mobile terminal according to a first embodiment of the invention.

FIGS. 11 to 15 are views illustrating examples of the method of controlling a mobile terminal according to the first embodiment.

FIG. 16 is a flowchart illustrating a method of controlling a mobile terminal according to a second embodiment of the invention.

FIGS. 17 to 19 are views illustrating examples of the method of controlling a mobile terminal according to the second embodiment.

FIG. 20 is a flowchart illustrating a method of controlling a mobile terminal according to a third embodiment of the invention.

FIG. 21 is a view illustrating examples of the method of controlling a mobile terminal according to the third embodiment.

FIG. 22 is a flowchart illustrating a method of controlling a mobile terminal according to a fourth embodiment of the invention.

FIGS. 23 to 26 are views illustrating examples of the method of controlling a mobile terminal according to the fourth embodiment.

### DETAILED DESCRIPTION

Reference will now be made in detail to the embodiments of the invention, examples of which are illustrated in the accompanying drawings. Throughout the specification, the same reference numerals refer to the same elements. Any specific descriptions on well known functions or constructions related to this document will be omitted if they are considered to cause the interpretation of the subject matters of this document ambiguous.

Further, a mobile terminal according to an embodiment will be described in greater detail with reference to drawings. Throughout the specification, terms “module”, “part”, and “unit” may be interchangeably used without making a difference in meaning from each other. Also, an ‘audio’ includes one or more of audio data, audio contents, audio signals, audio sounds, etc.

And, the mobile terminal according to an embodiment may include a cellular phone, a smart phone, a laptop computer, a digital broadcast terminal, a PDA (Personal Digital Assistant), a PMP (Portable Multimedia Player), a navigator, or the like.

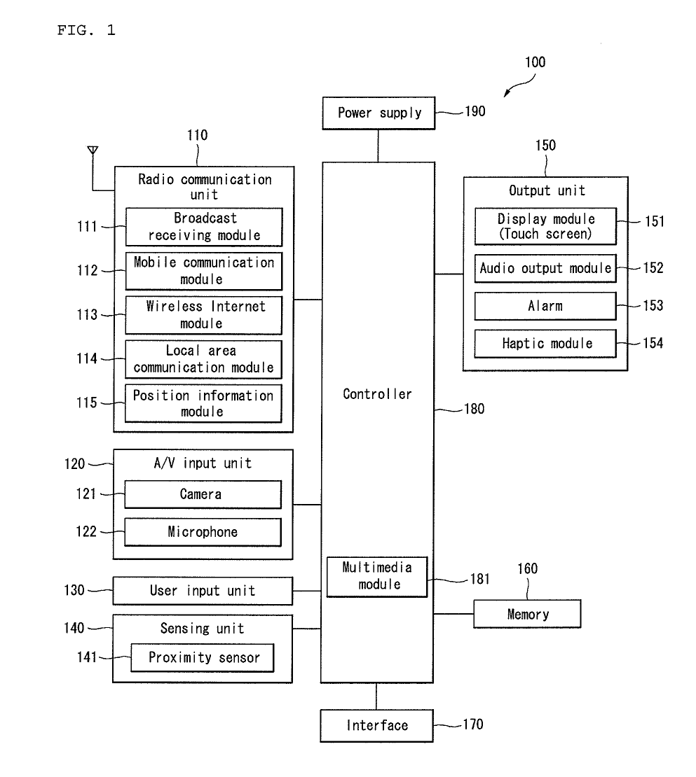

FIG. 1 is a block diagram of a mobile terminal 100 according to an embodiment. As shown, the mobile terminal 100 includes a radio communication unit 110, an audio/video (A/V) input unit 120, a user input unit 130, a sensing unit 140, an output unit 150, a memory 160, an interface 170, a controller 180, and a power supply 190.

In addition, the radio communication unit 110 includes at least one module that enables radio communication between the mobile terminal 100 and a radio communication system or between the mobile terminal 100 and a network in which the mobile terminal 100 is located. For example, the radio communication unit 110 includes a broadcasting receiving module 111, a mobile communication module 112, a wireless Internet module 113, a local area communication module 114 and a position information module 115.

The broadcasting receiving module 111 receives broadcasting signals and/or broadcasting related information from an external broadcasting management server through a broadcasting channel. Also, the broadcasting channel can include a satellite channel and a terrestrial channel, and the broadcasting management server can be a server that generates and transmits broadcasting signals and/or broadcasting related information or a server that receives previously created broadcasting signals and/or broadcasting related information and transmits the broadcasting signals and/or broadcasting related information to a terminal.

Further, the broadcasting signals can include not only TV broadcasting signals, radio broadcasting signals and data broadcasting signals, but also signals in the form of combination of a TV broadcasting signal and a radio broadcasting signal. In addition, the broadcasting related information can be information on a broadcasting channel, a broadcasting program or a broadcasting service provider, and can be provided even through a mobile communication network. In the latter case, the broadcasting related information can be received by the mobile communication module 112.

Also, the broadcasting related information can exist in various forms. For example, the broadcasting related information can exist in the form of an electronic program guide (EPG) of the digital multimedia broadcasting (DMB) system or in the form of an electronic service guide (ESG) of the digital video broadcast-handheld (DVB-H) system.

In addition, the broadcasting receiving module 111 receives broadcasting signals using various broadcasting systems. Particularly, the broadcasting receiving module 111 can receive digital broadcasting signals using digital broadcasting systems such as the digital multimedia broadcasting-terrestrial (DMB-T) system, the digital multimedia broadcasting-satellite (DMB-S) system, the media forward link only (MediaFLO) system, the DVB-H and integrated services digital broadcast-terrestrial (ISDB-T) systems, etc. The broadcasting receiving module 111 can also be constructed to be suited to broadcasting systems providing broadcasting signals other than the above-described digital broadcasting systems.

Further, the broadcasting signals and/or broadcasting related information received through the broadcasting receiving module 111 can be stored in the memory 160. The mobile communication module 112 transmits/receives a radio signal to/from at least one of a base station, an external terminal and a server on a mobile communication network. The radio signal can include a voice call signal, a video telephony call signal or data in various forms according to transmission and reception of text/multimedia messages.

In addition, the wireless Internet module 113 corresponds to a module for wireless Internet access and can be included in the mobile terminal 100 or externally attached to the mobile terminal 100. A wireless LAN (WLAN) (Wi-Fi), wireless broadband (Wibro), world interoperability for microwave access (Wimax), high speed downlink packet access (HSDPA) and so on can be used as a wireless Internet technique.

Also, the local area communication module 114 corresponds to a module for local area communication. Further, Bluetooth, radio frequency identification (RFID), infrared data association (IrDA), ultra wideband (UWB) and ZigBee can be used as a local area communication technique.

The position information module 115 confirms or obtains the position of the mobile terminal. In more detail, a global positioning system (GPS) module is a representative example of the position information module 115. In addition, the GPS module 115 can calculate information on distances between one point or object and at least three satellites and information on the time when the distance information is measured and apply trigonometry to the obtained distance information to obtain three-dimensional position information on the point or object according to the latitude, longitude and altitude at a predetermined time.

Furthermore, a method of calculating position and time information using three satellites and correcting the calculated position and time information using another satellite can also used. In addition, the GPS module or position information module 115 continuously calculates the current position in real time and/or calculates velocity information using the position information.

Referring to FIG. 1, the A/V input unit 120 is used to input an audio signal and/or a video signal and includes a camera 121 and/or a microphone 122. The camera 121 processes image frames of still images or moving images obtained by an image sensor in a video telephony mode or a photographing mode. Further, the processed image frames can be displayed on a display unit/module 151.

Also, the image frames processed by the camera 121 can be stored in the memory 160 or transmitted to an external device through the radio communication unit 110. The mobile terminal 100 can also include at least two cameras. The microphone 122 receives an external audio signal in a call mode, a recording mode or a speed recognition mode and processes the received audio signal into electric audio data.

The audio data can then be converted into a form that can be transmitted to a mobile communication base station through the mobile communication module 112 and output in the call mode. Further, the microphone 122 can employ various noise removal algorithms for removing noise generated when the external audio signal is received.

In addition, the user input unit 130 receives input data for controlling the operation of the terminal from a user. The user input unit 130 can include a keypad, a dome switch, a touch pad (constant voltage/capacitance), jog wheel, jog switch and so on.

Also, the sensing unit 140 senses the current state of the mobile terminal 100, such as an open/close state of the mobile terminal 100, the position of the mobile terminal 100, whether a user touches the mobile terminal 100, the direction of the mobile terminal 100 and the acceleration/deceleration of the mobile terminal 100, and generates a sensing signal for controlling the operation of the mobile terminal 100.

For example, the sensing unit 140 can sense whether a slide phone is opened or closed when the mobile terminal 100 is the slide phone. Furthermore, the sensing unit 140 can sense whether the power supply 190 supplies power and whether the interface 170 is connected to an external device. The sensing unit 140 can also include a proximity sensor.

In addition, the output unit 150 generates visual, auditory or tactile output and can include the display unit 151, an audio output module 152, an alarm 153 and a haptic module 154. Further, the display unit 151 displays information processed by the mobile terminal 100. For example, the display unit 151 displays a user interface (UI) or graphic user interface (GUI) related to a telephone call when the mobile terminal is in the call mode. The display unit 151 also displays a captured or/and received image, UI or GUI when the mobile terminal 100 is in the video telephony mode or the photographing mode.

In addition, the display unit 151 can include at least one of a liquid crystal display, a thin film transistor liquid crystal display, an organic light-emitting diode display, a flexible display and a three-dimensional display. Further, some of these displays can be of a transparent type or a light transmission type. That is, the display unit 151 can include a transparent display.

In more detail, the transparent display includes a transparent liquid crystal display. Further, the rear structure of the display unit 151 can also be of the light transmission type. Accordingly, a user can see an object located behind the body of the mobile terminal 100 through the transparent area of the body of the mobile terminal 100, which is occupied by the display unit 151.

The mobile terminal 100 can also include at least two display units 151. For example, the mobile terminal 100 can include a plurality of displays that are arranged on a single face at a predetermined distance or integrated displays. The plurality of displays can also be arranged on different sides.

In addition, when the display unit 151 and a sensor sensing touch (referred to as a touch sensor hereinafter) form a layered structure, which is referred to as a touch screen hereinafter, the display unit 151 can be used as an input device in addition to an output device. The touch sensor can be in the form of a touch film, a touch sheet and a touch pad, for example.

Further, the touch sensor can be constructed to convert a variation in pressure applied to a specific portion of the display unit 151 or a variation in capacitance generated at a specific portion of the display unit 151 into an electric input signal. The touch sensor can also be constructed to sense pressure of touch as well as the position and area of the touch.

Also, when the user applies touch input to the touch sensor, a signal corresponding to the touch input is transmitted to a touch controller. The touch controller then processes the signal and transmits data corresponding to the processed signal to the controller 180. Accordingly, the controller 180 can detect a touched portion of the display 151.

Referring to FIG. 1, the proximity sensor of the sensing unit 140 can be located in an internal region of the mobile terminal, surrounded by the touch screen, or near the touch screen. The proximity sensor senses an object approaching a predetermined sensing face or an object located near the proximity sensor using an electromagnetic force or infrared rays without having mechanical contact. Further, the proximity sensor has lifetime longer than that of a contact sensor and thus has a wide application in the mobile terminal 100.

In addition, the proximity sensor includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, an infrared proximity sensor, etc. Further, a capacitive touch screen is constructed such that proximity of a object is detected through a variation in an electric field according to the proximity of the object. In this instance, the touch screen (touch sensor) can be classified as a proximity sensor.

For convenience of explanation, the action of the object approaching the touch screen without actually touching the touch screen is referred to as “proximity touch” and an action of bringing the object into contact with the touch screen is referred to as “contact touch” in the following description. In addition, the proximity touch point of the object on the touch screen corresponds to a point of the touch screen to which the object touches the touch screen.

Further, the proximity sensor senses the proximity touch and a proximity touch pattern (for example, a proximity touch distance, a proximity touch direction, a proximity touch velocity, a proximity touch time, a proximity touch position, a proximity touch moving state, etc.). Information corresponding to the sensed proximity touch action and proximity touch pattern can then be displayed on the touch screen.

Also, the audio output module 152 can output audio data received from the radio communication unit 110 or stored in the memory 160 in a call signal receiving mode, a telephone call mode or a recording mode, a speech recognition mode and a broadcasting receiving mode. Further, the audio output module 152 outputs audio signals related to functions (for example, a call signal incoming tone, a message incoming tone, etc.) performed in the mobile terminal 100. The audio output module 152 can include a receiver, a speaker, a buzzer, etc.

In addition, the alarm 153 outputs a signal for indicating the generation of an event of the mobile terminal 100. For example, alarms can be generated when receiving a call signal, receiving a message, inputting a key signal, inputting a touch, etc. The alarm 153 can also output signals in forms different from video signals or audio signals, for example, a signal for indicating generation of an event through vibration. The video signals or the audio signals can be also output through the display unit 151 or the audio output module 152.

Also, the haptic module 154 generates various haptic effects that the user can feel. One representative example of the haptic effects is vibration. The intensity and pattern of vibration generated by the haptic module 154 can also be controlled. For example, different vibrations can be combined and output or can be sequentially output.

Further, the haptic module 154 can generate a variety of haptic effects including an effect of stimulus according to arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 can also not only transmit haptic effects through direct contact but also allow the user to feel haptic effects through a kinesthetic sense of the user's fingers or arms. The mobile terminal 100 can also include multiple haptic modules 154.

In addition, the memory 160 can store a program for the operation of the controller 180 and temporarily store input/output data (for example, phone book, messages, still images, moving images, etc.). The memory 160 can also store data about vibrations and sounds in various patterns, which are output from when a touch input is applied to the touch screen.

Further, the memory or storage unit 160 can include at least one of a flash memory, a hard disk type memory, a multimedia card micro type memory, a card type memory (for example, SD or XD memory), a random access memory (RAM), a static RAM (SRAM), a read-only memory (ROM), an electrically erasable programmable ROM (EEPROM), a programmable ROM (PROM) magnetic memory, a magnetic disk and an optical disk. The mobile terminal 100 can also operate in relation to a web storage performing the storing function of the memory 160 on the Internet.

The interface 170 serves as a path to external devices connected to the mobile terminal 100. Further, the interface 170 receives data from the external devices or power and transmits the data or power to the internal components of the mobile terminal 100 or transmits data of the mobile terminal 100 to the external devices. Also, the interface 170 can include a wired/wireless headset port, an external charger port, a wired/wireless data port, a memory card port, a port for connecting a device having a user identification module, an audio I/O port, a video I/O port, an earphone port, etc., for example.

In addition, the interface 170 can also interface with a user identification module that is a chip that stores information for authenticating the authority to use the mobile terminal 100. For example, the user identification module can be a user identify module (UIM), a subscriber identify module (SIM) and a universal subscriber identify module (USIM). An identification device including the user identification module can also be manufactured in the form of a smart card. Accordingly, the identification device can be connected to the mobile terminal 100 through a port of the interface 170.

The interface 170 can also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle can be used as signals for confirming whether the mobile terminal is correctly set in the cradle.

In addition, the controller 180 controls the overall operations of the mobile terminal 100. For example, the controller 180 performs control and processing for voice communication, data communication and video telephony. As shown in FIG. 1, the controller 180 also includes a multimedia module 181 for playing multimedia. Also, the multimedia module 181 can be included in the controller 180 as shown in FIG. 1 or can be separated from the controller 180.

Further, the controller 180 can perform a pattern recognition process capable of recognizing handwriting input or picture-drawing input applied to the touch screen as characters or images. In addition, the power supply 190 receives external power and internal power and provides power required for the operations of the components of the mobile terminal under the control of the controller 180. All the components of the mobile terminal 100 are operatively coupled and configured.

Next, FIG. 2 is a front perspective view of one example of the mobile terminal or handheld terminal 100 according to an embodiment. In this example, the handheld terminal 100 is a bar type terminal body. However, the embodiment is not limited to a bar type terminal and can be applied to terminals of various types including slide type, folder type, swing type and swivel type terminals.

In addition, the terminal body includes a case (a casing, a housing, a cover, etc.) forming the exterior of the terminal 100. In the present embodiment, the case is divided into a front case 101 and a rear case 102. Further, various electronic components are arranged in the space formed between the front case 101 and the rear case 102. At least one middle case can also be additionally arranged between the front case 101 and the rear case 102. Also, the cases can be formed of plastics through injection molding or made of a metal material such as stainless steel (STS) or titanium (Ti).

As shown in FIG. 2, the display unit 151, the audio output unit 152, the camera 121, operating units 131 and 132, the microphone 122 and the interface 170 are arranged in the terminal body, specifically, in the front case 101. In addition, the display unit 151 occupies most of the main face of the front case 101.

Further, the audio output module 152 and the camera 121 are arranged in a region in proximity to one of both ends of the display unit 151. Also, the user input unit 131 and the microphone 122 are located in a region in proximity to the other end of the display unit 151. Also include is another user input unit 132, which is arranged with the interface 170 on the sides of the front case 101 and the rear case 102.

Thus, in this embodiment, the user input unit 130 includes the multiple operating units 131 and 132 that are operated to receive commands for controlling the operation of the handheld terminal 100. Further, the operating units 131 and 132 can be referred to as manipulating portions and employ any tactile manner in which a user operates the operating units 131 and 132 while producing a tactile feeling.

Also, the operating units 131 and 132 can receive various inputs. For example, the operating unit 131 receives commands such as start and end a call, and the operating unit 132 receives commands such as to control the volume of the sound output from the audio output unit 152 or to convert the display unit 151 into a touch recognition mode.

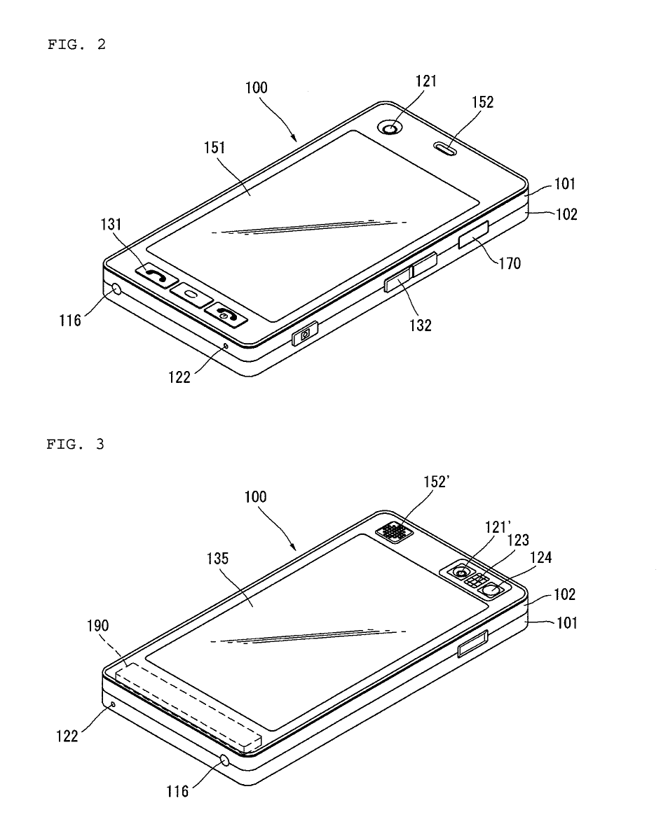

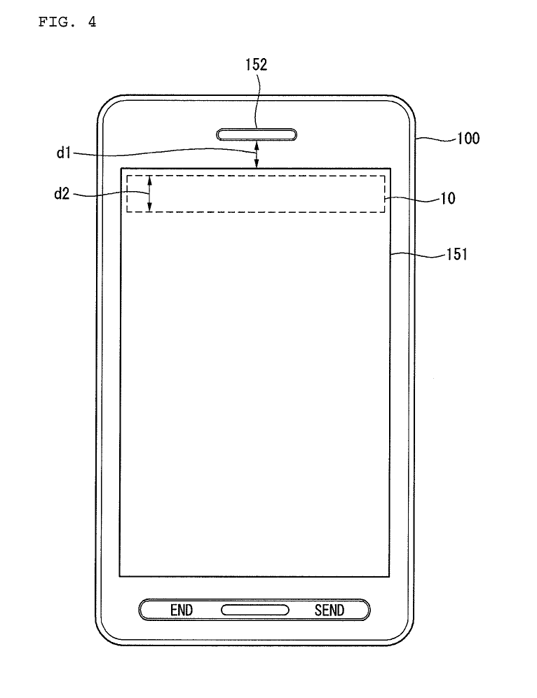

Next, FIG. 3 is a rear perspective view of the handheld terminal shown in FIG. 2 according to an embodiment. As shown in FIG. 3, a camera 121′ is additionally attached to the rear side of the terminal body, that is, the rear case 102. In this configuration, the camera 121′ has a photographing direction that is opposite to that of the camera 121 shown in FIG. 2 and can have pixels different from those of the camera 121 shown in FIG. 2.

For example, in one example, it is preferable that the camera 121 has low pixels such that it can capture an image of the face of a user and transmit the image to a receiving part during video telephony while the camera 121′ has high pixels such that it can capture an image of a general object and does not immediately transmit the image in many situations. The cameras 121 and 121′ can also be attached to the terminal body such that they can be rotated or popped-up.

As shown in FIG. 3, a flash bulb 123 and a mirror 124 are additionally arranged in proximity to the camera 121′. The flash bulb 123 lights an object when the camera 121′ takes a picture of the object, and the mirror 124 is used for the user to look at his or her face when the user wants to take a picture of themselves using the camera 121′.

An audio output unit 152′ is also additionally provided on the rear side of the terminal body. In this embodiment, the audio output unit 152′ can achieve a stereo function with the audio output unit 152 shown in FIG. 2 and be used in a speaker phone mode when the terminal is used for a telephone call.

A broadcasting signal receiving antenna can also be additionally attached to a side of the terminal body in addition to an antenna for telephone calls. The antenna forming a part of the broadcasting receiving module 111 shown in FIG. 1 can be set in the terminal body such that the antenna can be pulled out of the terminal body.

In addition, the power supply 190 for providing power to the handheld terminal 100 is set in the terminal body, and can be included in the terminal body or detachably attached to the terminal body. FIG. 3 also illustrates a touch pad 135 for sensing touch additionally attached to the rear case 102 of the terminal 100. Further, the touch pad 135 can be a light transmission type as the display module 151. In this instance, when the display module 151 outputs visual information through both sides, the visual information can be recognized through the touch pad 135.

Also, the information output through both sides of the display module 151 can be controlled by the touch pad 135. In addition, a display can be additionally attached to the touch pad 135 such that a touch screen can be arranged even in the rear case 102. Further, the touch pad 135 operates in connection with the display module 151 of the front case 101, and can be located in parallel with the display module 151 behind the display module 151. The touch pad 135 can also be identical to or smaller than the display unit 151 in size.

The embodiments as disclosed throughout the document may be implemented by the mobile terminal 100 as described above with reference to FIGS. 1 to 3. Hereinafter, structures and operation of the mobile terminal 100 according to the embodiments will be described in greater detail.

The controller 180 may sense an object approaching the audio output module 152 through the sensing unit 140. The controller 180 may be arranged to sense the object approaching the audio output module 152.

The controller 180 may be a touch device arranged to be adjacent to the audio output module 152. For example, the display unit 151 may be implemented as a touch screen.

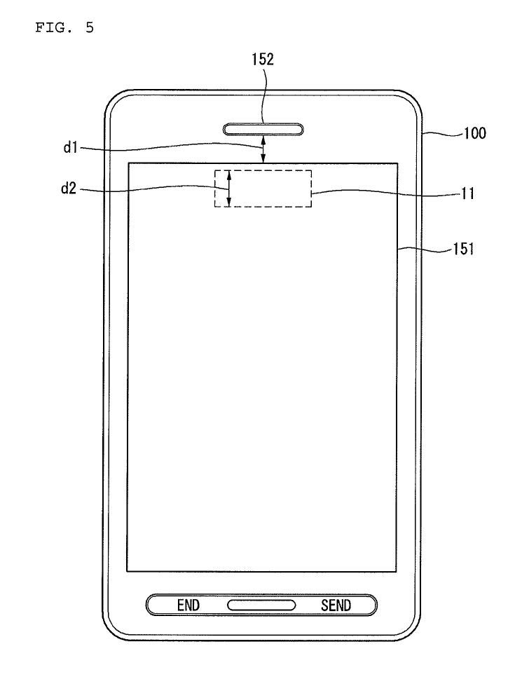

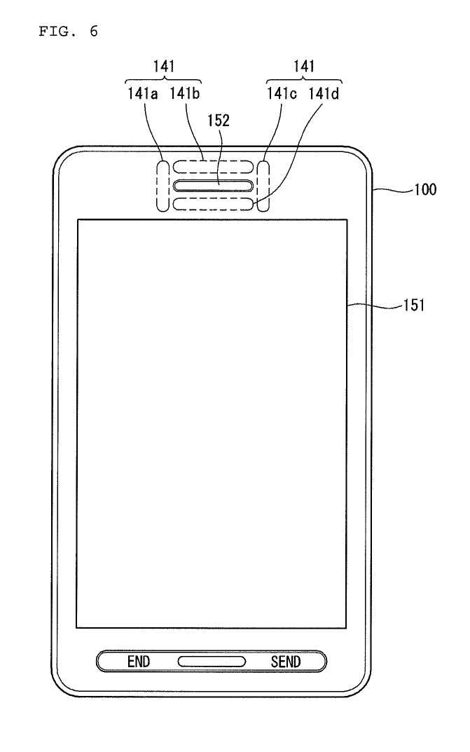

FIGS. 4 and 5 are views illustrating sensing an object approaching the audio output module 152 by using the display unit 151. Referring to FIGS. 4 and 5, the display unit 151 may be arranged to be spaced from the audio output module 152 by a distance d1.

The controller 180 may set a specific region included in the display unit 151 as a region for sensing an object approaching the audio output module 152.

For example, referring to FIG. 4 or 5, the controller 180 may set a first region 10 or a second region 11 that is included in the display unit 151 and has a width of d2 as a region for sensing an object approaching the audio output module 152. Here the width d2 can also be called a height d2.

The controller 180 may recognize that an object approaches the audio output module 152 in case of receiving a touch signal through the first region 10 or second region 11.

In addition, the controller 180 may be or include the proximity sensor 141. The proximity sensor 141 may be arranged at a location corresponding to the audio output module 152. For example, the proximity sensor 141 or the like may be positioned in parts 10, 11 of the display unit 151 as shown in FIGS. 4 and 5. In addition to or in lieu of such proximity sensor 141, the proximity sensor 141 may be positioned outside the display unit 151 and surrounds the audio output module 152 as shown in FIGS. 6-8. The proximity sensor 141 can sense an object near the sensor 141 but can also sense a direct contact of the sensor area by the object.

FIGS. 6 to 8 are views illustrating different examples of the proximity sensor 141 that is arranged at a location corresponding to the audio output module 152.

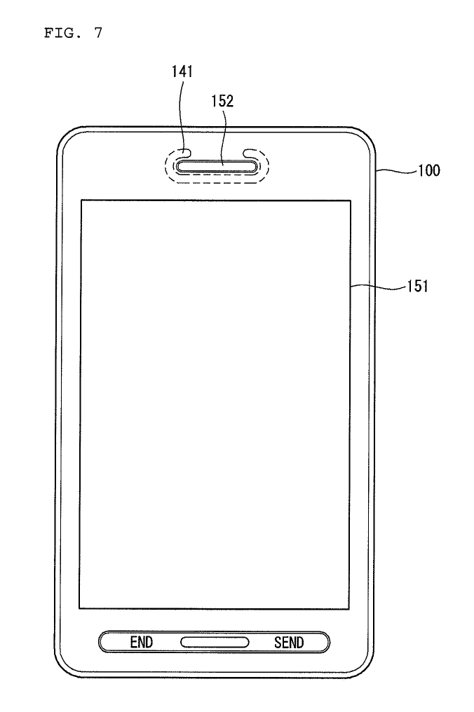

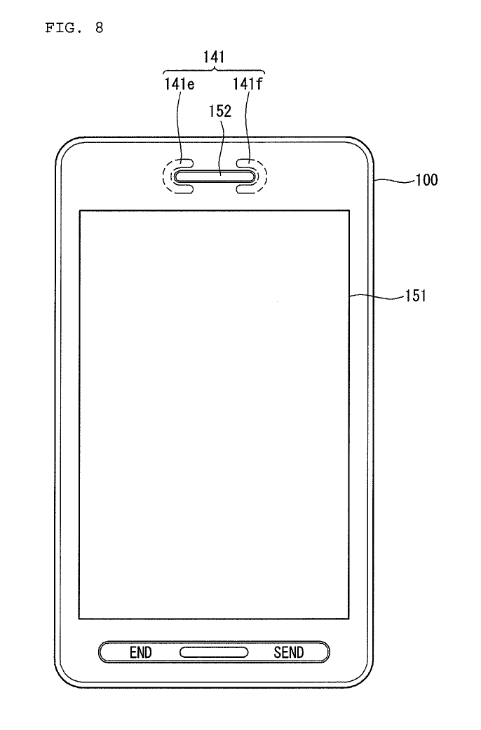

Referring to FIGS. 6 to 8, the proximity sensor 141 may recognize an object in a case where the object comes within a predetermined distance before physically contacting the audio output module 152 as described above with reference to FIG. 1. The proximity sensor 141 can include one or more sensor units 141a-141d disposed around the audio output module 152 as shown in FIG. 6, can be one sensor surrounding completely or part of the audio output module 152 as shown in FIG. 7, or can be multiple sensor units 141e, 141f surrounding parts of the audio output module 152 as shown in FIG. 8. These are mere examples and other variations are possible.

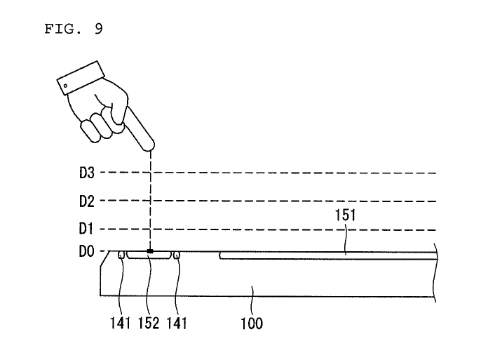

The proximity sensor 141 described with reference to FIGS. 1 and 4-8 will now be explained in more detail with reference to FIG. 9. FIG. 9 is a conceptual diagram used for explaining a proximity depth of the proximity sensor 141.

As shown in FIG. 9, when an object such as a user's finger, stylus, etc. approaches the audio output module 152, the proximity sensor 141 located inside the display unit 151 or near the audio output module 152 senses the approach and outputs a proximity signal as shown in FIGS. 4 to 8.

The proximity sensor can be constructed such that it outputs a proximity signal according to the distance between the object approaching the audio output module 152 and the audio output module 152 (hereinafter, referred to as “proximity depth”).

Also, the distance in which the proximity signal is output when the object approaches the audio output module 152 is referred to as a detection distance. The proximity depth can be determined using a plurality of proximity sensors having different detection distances and comparing proximity signals respectively output from the proximity sensors.

FIG. 9 shows the section of the audio output module 152 in which proximity sensors 141 capable of sensing three proximity depths are arranged according to one example. Of course, proximity sensors capable of sensing less than three or more than three proximity depths can be arranged in the display unit 141 or in or near the audio output module 152.

Specifically, when the object completely comes into contact with the touch screen (d0), the controller 180 recognizes this action as the contact touch. When the object is located within a distance d1 from the audio output module 152, the controller 180 recognizes this action as a proximity touch of a first proximity depth.

Similarly, when the object is located in a range between the distance d1 and a distance d2 from the audio output module 152, the controller 180 recognizes this action as a proximity touch of a second proximity depth. When the object is located in a range between the distance d2 and a distance d3 from the audio output module 152, the controller 180 recognizes this action a proximity touch of a third proximity depth. Also, when the object is located at longer than the distance d3 from the audio output module 152, the controller 180 recognizes this action as a cancellation of proximity touch.

Accordingly, the controller 180 can recognize the proximity touch as various input signals according to the proximity distance and proximity position of the object with respect to the audio output module 152 and perform various operations according to the input signals.

Hereinafter, embodiments will be described. It is assumed in this document for the convenience of description that the display unit 151 is a touch screen. As mentioned above, the touch screen may perform both an information display function and an information input function. However, it should be noted that the embodiment is not limited thereto.

Unless the display unit 151 is a touch screen, as described above, the proximity sensor 141 may be arranged near the audio output module 152 or inside the display unit 151. It is obvious that the mobile terminal 100 may include both the proximity sensor 141 and the display unit 151.

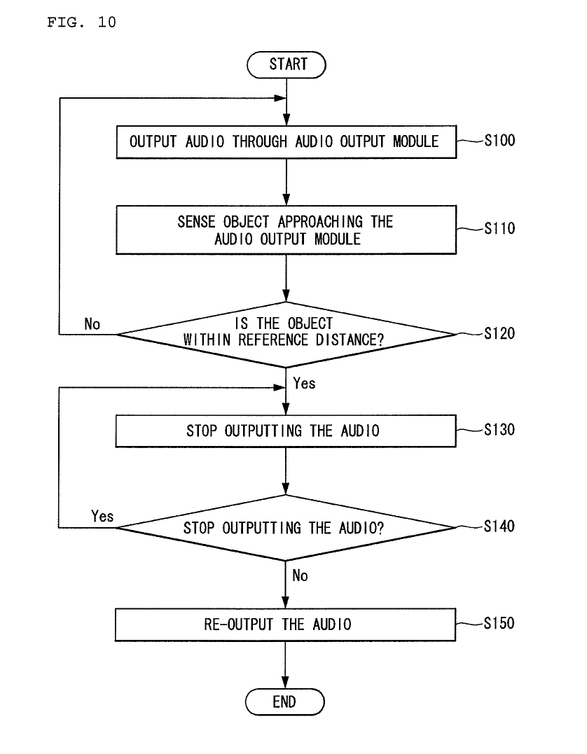

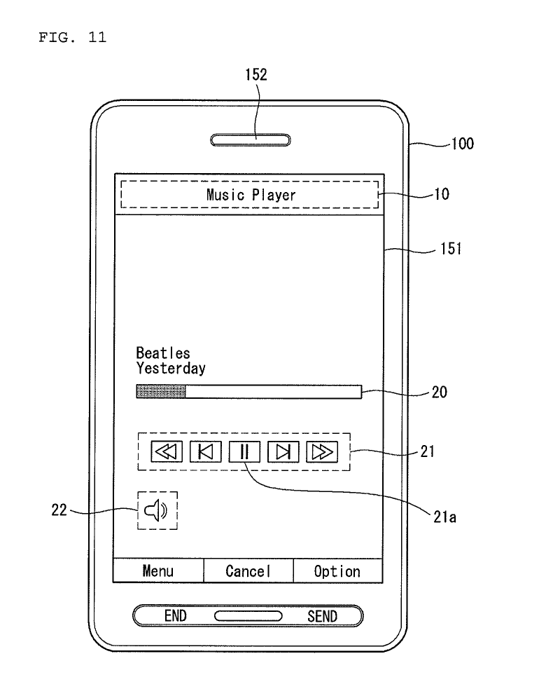

FIG. 10 is a flowchart illustrating a method of controlling a mobile terminal according to a first embodiment. FIGS. 11 to 15 are views illustrating a method of controlling a mobile terminal according to the first embodiment.

The method of controlling the mobile terminal according to the first embodiment may be implemented by the mobile terminal 100 as described above with reference to FIGS. 1 to 9. Further, the various methods of FIGS. 10-26 can be preferably implemented in the mobile terminal 100 of FIGS. 1-9. However, these methods of FIGS. 10-26 may be implemented in other suitable device or system. Hereinafter, the method of controlling the mobile terminal according to the first embodiment and operation of the mobile terminal 100 implementing the method will be described in greater detail with reference to accompanying drawings.

Referring to FIG. 10, the controller 180 outputs a first audio through the audio output module 152 (S100).

A source of the first audio and an application activated to output the first audio may be various.

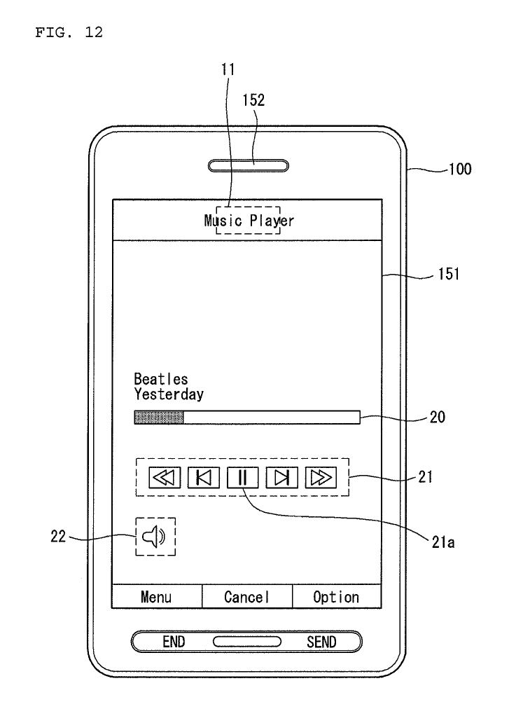

For example, the first audio may be music. FIGS. 11 and 12 illustrate an example of a screen on which music is played. A user may search and select a menu provided by the controller 180 and activate a music player as shown in FIGS. 11 and 12 to select and replay specific music.

As shown in FIGS. 11 and 12, the music player may include a progress bar 20, a functional icon group 21 containing a plurality of functional icons, and an output mode icon 22 representing an output mode.

The progress bar 20 represents the overall section of music as selected currently and a section as currently reproduced.

The functional icon group 21 may include a replay icon 21a to which a playing function and a pausing function have been assigned.

If a user selects the replay icon 21a, the controller 180 replays music as currently selected. When the user selects the replay icon 21a while the music is replayed, the controller 180 may pause the playback of the music.

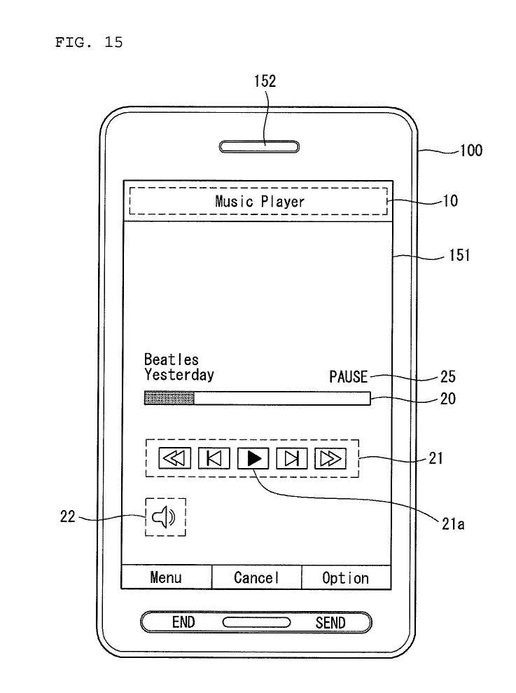

Further, the graphic of the replay icon 21a may be changed depending on the playback or pause. For example, the replay icon 21a as shown in FIGS. 11 and 12 represents that the music is currently playing back. For example, the replay icon 21a as shown in FIG. 15 represents that the playback of the music pauses.

The output mode icon 22 represents whether the music is replayed while outputted through a speaker or while kept mute. In a case where the music is replayed while being kept mute, the controller 180 does not output the music through the speaker. The output mode icon 22 as shown in FIGS. 11 and 12 represents the music is currently outputted through the speaker.

The sources of the music outputted through the music player may be various. For example, the music may be stored in the memory 160 or downloaded over an external communication network such as the Internet.

Further, the first audio may be an audio that is outputted together with a video.

The first audio may include all types of audios as well as the one disclosed herein.

In a case where there is an object (e.g., finger, stylus, pen, etc.) approaching the audio output module 152 (e.g., an area where the speaker or speaker hole is located shown in FIG. 4 or the like), the controller 180 senses the object approaching the audio output module 152 (S110) and determines whether the sensed object comes within a predetermined reference distance from the audio output module 152 (S120). For instance, if the user desires to control the outputting of the audio on the mobile terminal 100, then the user can place a finger over or near the speaker hole (associated with the audio output module 152) without direct contact, or can touch the speaker hole area. Then the controller 180 senses this and considers it as a user command input if the finger is within a certain range of the audio output module 152.

The way of sensing the object approaching the audio output module 152 by the controller 180 may be various as described above with reference to FIGS. 4 to 9.

FIGS. 11 and 12 illustrate a case where the controller 180 may sense an object approaching the audio output module 152 using the display unit 151 as described above with reference to FIGS. 4 and 5.

As described above with reference to FIGS. 4 and 5, the controller 180 may provide the first region 10 and the second region 11 to the display unit 151 to sense an object approaching the audio output module 152.

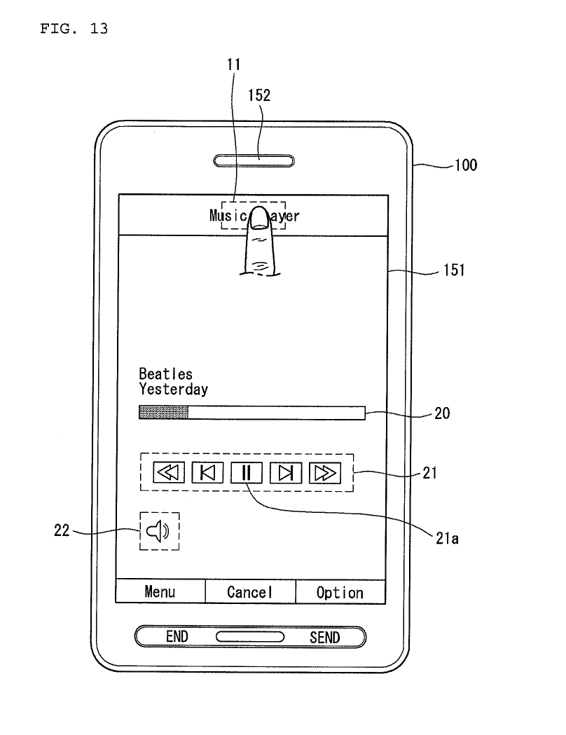

FIGS. 13 to 15 illustrate a case where the second region 11 is provided to the display unit 151.

In a case where it is determined in step S120 that the object comes within the reference distance, the controller 180 stops outputting the audio through the audio output module 151 (S130).

For example, as shown in FIG. 13, when sensing a touch (contact) of the object on the second region 20 in the display unit 151 near the audio output module 151, the controller 180 may determine that the object is within the reference distance from the audio output module 152 and thus stops the output of the audio from the audio output module 151.

Further, in a case where the first region 10 provided to the display unit 151 by the controller 180 is sensed to be touched or contacted by the object, the controller 180 may also stop the output of the audio similarly to where the second region 11 is touched by the object. In a variation, if the controller 180 determines that the object is within a reference distance from the first or second region 10, 20 of the display unit 151 (proximity sensing), then it may stop the output of the audio.

In a case where the mobile terminal 100 includes the proximity sensor 141 as shown in FIGS. 6 to 8, the controller 180 may stop the output of the audio when it is determined through the proximity sensor 141 that the object is within the reference distance from the audio output module 152, for example, when the object is near the audio output module 152's area.

The controller 180 may stop the output of the audio in various modes such as a mode of muting the audio, a mode of pausing the audio, etc.

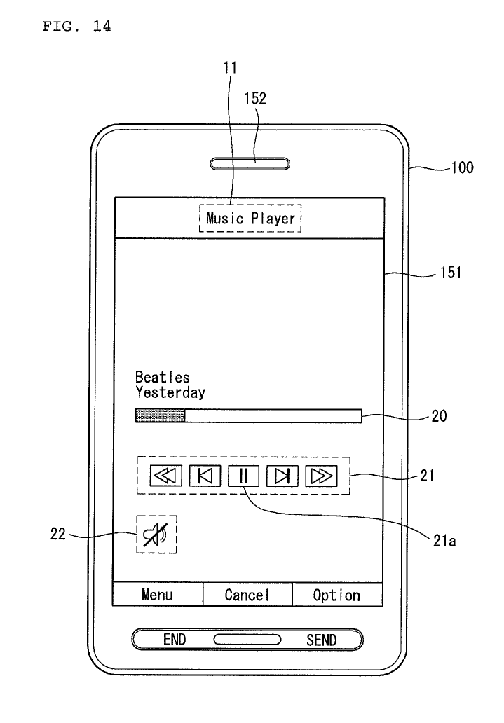

For example, as shown in FIG. 14, the controller 180 may mute the audio. In this case, the controller 180 maintains or continues to replay the audio but does not output the audio through the speaker.

In case of muting the audio, the controller 180 may change the graphic of the output mode icon 22 as shown in FIG. 14. In FIG. 14, the graphic of the output mode icon 22 represents the music is currently in a mute state and the graphic of the replay icon 21a the music is replaying. That is, the screen shown in FIG. 14 represents the music is replaying in the mute state.

In another example, referring to FIG. 15, the controller 180 may pause the audio. According to the pause of the audio, the replay of the audio is stopped so that the audio is not outputted through the speaker.

As mentioned above, according to the pause of the audio indicated with an indicator 25, the controller 180 may change the graphic of the replay icon 21a as shown in FIG. 15.

The controller 180 may determine whether or not the approach of the object to the audio output module 152 is maintained (S140).

In a case where it is determined in step S140 that the approach to the audio output module 152 is maintained (e.g., for a predetermined duration), the controller 180 maintains the stopping of the output of the audio.

In a case where it is determined in step S140 that the approach to the audio output module 152 is not maintained (e.g., for a predetermined duration), the controller 180 re-outputs the audio through the speaker such that the audio is output and heard (S150).

Further, even when the user removes his finger from the second region 20, the controller 180 may maintain the stopping of the output of the audio.

When the user selects the replay icon 21a after removing his finger from the second region 20, the controller 180 may re-output the audio.

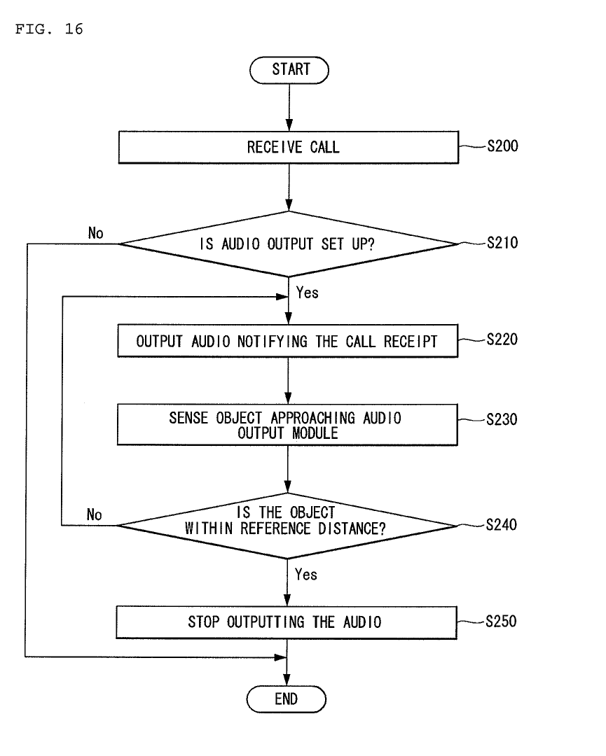

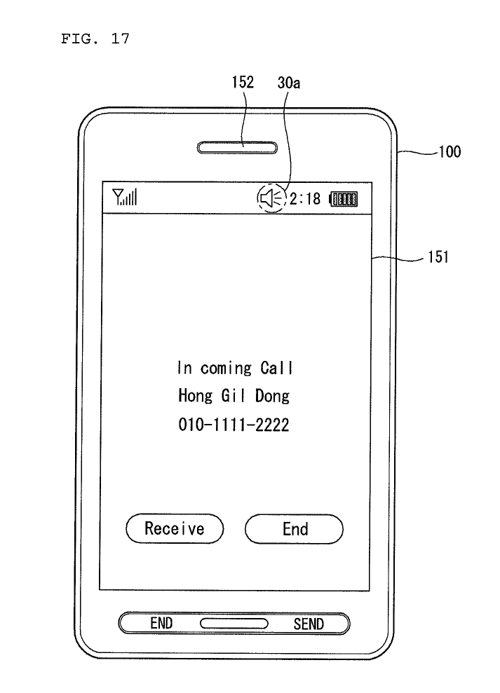

FIG. 16 is a flowchart illustrating a method of controlling a mobile terminal according to a second embodiment. FIGS. 17 to 19 are views illustrating the method of controlling a mobile terminal according to the second embodiment.

The method of controlling the mobile terminal according to the second embodiment may be implemented by the mobile terminal 100 as described above with reference to FIGS. 1 to 9. Hereinafter, the method of controlling the mobile terminal according to the second embodiment and operation of the mobile terminal 100 implementing the method will be described in greater detail with reference to accompanying drawings.

Referring to FIG. 16, the controller 180 may receive a call through the mobile communication module 112 or the wireless Internet module 113 (S200).

In general, when the mobile terminal 100 receives a call, information on the receipt of the call may be communicated to a user. In this case, the information on the receipt of the call may be provided visually, audibly, tactually, or in a combination thereof, via the mobile terminal 100.

As an example of visually providing the information, the controller 180 may provide the display unit 151 with a call receipt screen containing information on a caller of a call (e.g., sender information) as the controller 180 receives the call.

Further, as an example of audibly providing the information, the controller 180 may output a predetermined audio through the audio output module 152 as the controller 180 receives a call (hereinafter, referred to as “audio mode”). The predetermined audio can also be called “ring tone” which can include ring tones or other sounds.

Further, as an example of tactually providing the information, the controller 180 may control the haptic module 154 to generate a predetermined pattern of vibration as the controller 180 receives a call (hereinafter, referred to as “vibration mode”).

On the other hand, the controller 180 may provide only visual information without activating the audio mode and/or the vibration mode as the controller 180 receives a call (hereinafter, referred to as “silent mode”).

In general, any one of the audio mode, the vibration mode, the silent mode, and a combination thereof is set as a mode of the mobile terminal 100.

When receiving a call, the controller 180 determines whether the audio mode is set up (S210). If it is determined in step S210 that the audio mode is set up, the controller 180 outputs an audio notifying the receipt of the call through the mobile terminal 100 (S220).

FIG. 17 is a view illustrating an exemplary screen provided when a call is received at the mobile terminal 100.

Reference numeral 30a in FIG. 17 refers to a call notification icon 30a that represents any one of the audio mode, the vibration mode, the silent mode, and a combination thereof.

The call notification icon 30a in FIG. 17 represents that the audio mode is currently set.

The controller 180 may sense an object approaching the audio output module 152 as discussed above while outputting the audio notifying the receipt of the call (S230). And, the controller 180 determines whether the sensed object comes within a predetermined reference distance from the audio output module 152 (S240). Here, steps S230 and S240 encompass the various ways of detection discussed in connection with FIGS. 4-9. For example, if a contact on (or approach to) the first or second region 10 or 11 in the display unit 151 is detected, then this detection means the object has come within the predetermined reference distance from the audio output module 152.

Steps S230 and S240 are identical (or similar to) to steps S110 and S120, respectively, in the first embodiment, and thus the detailed descriptions will be omitted.

FIG. 18 illustrates an exemplary screen associated with one example of step S230.

FIG. 18 depicts a situation where a user brings his finger close to the audio output module 152 or the proximity sensor 141 in a case where the proximity sensor 141 is provided around the audio output module 152.

In FIG. 18, the controller 180 may determine whether the user's finger approaches within the reference distance from the audio output module 152 through the proximity sensor 141 before the finger is brought in touch with the audio output module 152.

If it is determined in step S240 that the object (i.e., the user's finger in this example) is within the reference distance, the controller 180 stops outputting the audio (S250). Otherwise, the method returns to step S220. Step S250 is identical to (or similar to) step S130 in the first embodiment and the detailed descriptions will be omitted.

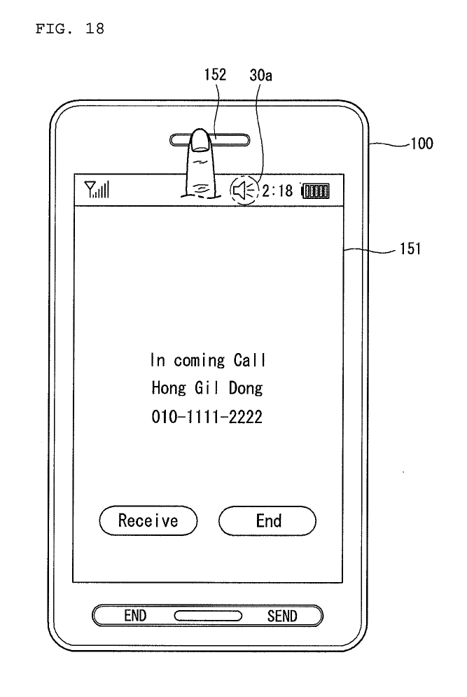

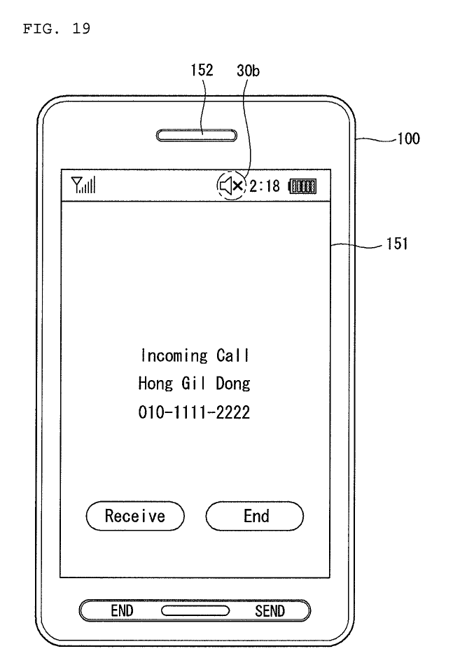

As the controller 180 stops outputting the audio, the controller 180 may change the graphic of the call notification icon 30a as shown in FIG. 19 to the icon 30b. The graphic of the call notification icon 30b shown in FIG. 19 represents the silent mode.

FIG. 20 is a flowchart illustrating a method of controlling a mobile terminal according to a third embodiment.

The method of controlling the mobile terminal according to the third embodiment may be implemented by the mobile terminal 100 as described above with reference to FIGS. 1 to 9. Hereinafter, the method of controlling the mobile terminal according to the third embodiment and operation of the mobile terminal 100 implementing the method will be described in greater detail with reference to accompanying drawings.

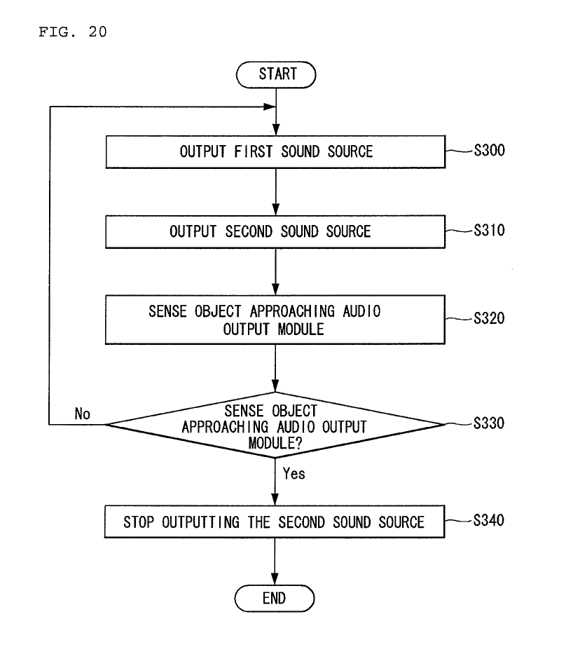

Referring to FIG. 20, the controller 180 outputs a first sound source through the audio output module 152 (S300). As shown in FIG. 21, for example, the controller 180 may output first music through the music player or other device in the mobile terminal 100 (S400).

The controller 180 outputs a second sound source through the audio output module 152 while outputting the first sound source (S310). As shown in FIG. 21, for example, while outputting the first music, the controller 180 may drive a web browser according to a user's instruction (S410) and use the web browser to access a certain web site through the mobile communication module 112 or the wireless Internet module 113 (S420). The accessed web site may provide second music corresponding to the second sound source. The controller 180 receives the second music from the accessed web site and outputs the received second music through the audio output module 152 (S430).

Accordingly, the controller 180 may simultaneously output both the first music outputted before accessing the web site and the second music provided from the accessed web site.

Then the controller 180 may sense an object (e.g., finger, stylus, or other object) approaching the audio output module 152 while outputting the first and second sound sources (S320). And, the controller 180 determines whether the sensed object approaches within a predetermined reference distance from the audio output module 152 (S330).

Steps S320 and S330 are identical to (or similar to) steps S110 and S120 in the first embodiment or steps S230 and S240 in the second embodiment, and the detailed descriptions will be omitted.

Step S440 in FIG. 21 depicts an example of implementing steps S320 and S330.

If it is determined in step S330 that the object is within the reference distance of the audio output module 152, the controller 180 may stop outputting the second sound source (S340). Step S340 is identical to (or similar to) step S130 in the first embodiment or step S250 in the second embodiment and the detailed descriptions will be omitted.

In step S340, the controller 180 may maintain the output of the first sound source while the outputting of the second sound source is stopped.

Referring to FIG. 21, in case of not wanting to listen to the second music provided from the accessed web site, the user may bring his finger close to the audio output module 152 to stop outputting the second music while continuously listening to the first music outputted from before accessing the web site (S450).

In the example of FIG. 21, the output of the lastly obtained sound (i.e., the second sound source) is stopped while the firstly obtained sound (i.e., the first sound source) is continuously output when the object is determined to be near the audio output module 152. As a variation, the output of the firstly obtained sound (i.e., the first sound source) may be stopped while the lastly obtained sound (i.e., the second sound source) may be continuously output when the object is determined to be near the audio output module 152. In still another variation, the output of all the currently playing sound sources may be stopped when the object is determined to be near the audio output module 152. Further, one of these and other variations may be pre-selected by the user and the settings of the mobile terminal 100 can be set by the user accordingly, so that the mobile terminal 100 responds according to the user's preferences based on the settings when an object approaches the audio output module 152.

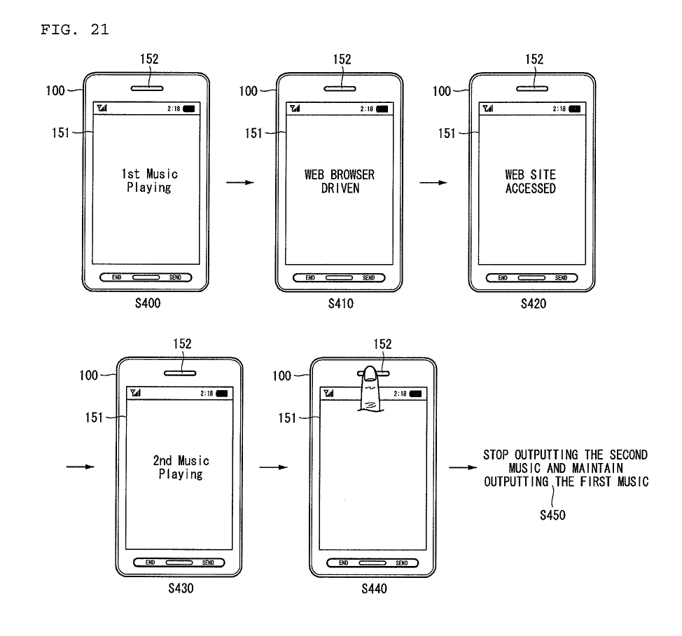

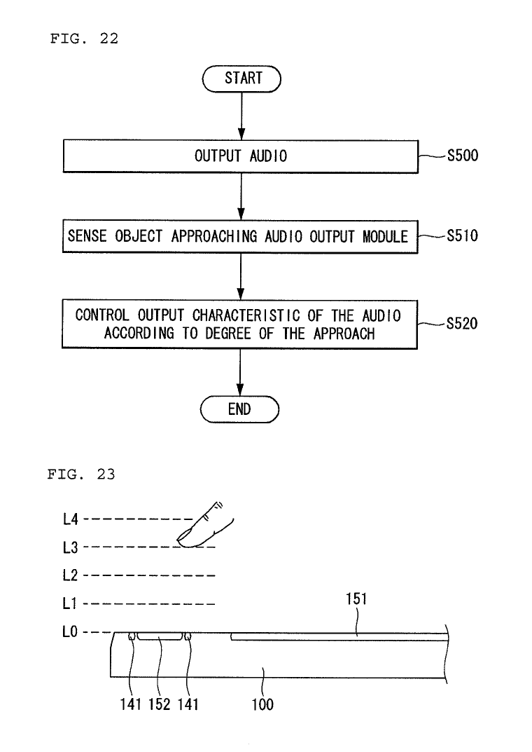

FIG. 22 is a flowchart illustrating a method of controlling a mobile terminal according to a fourth embodiment. FIGS. 23 to 26 are views illustrating the method of controlling a mobile terminal according to the fourth embodiment.

The method of controlling the mobile terminal according to the fourth embodiment may be implemented by the mobile terminal 100 as described above with reference to FIGS. 1 to 9. Hereinafter, the method of controlling the mobile terminal according to the fourth embodiment and operation of the mobile terminal 100 implementing the method will be described in greater detail with reference to accompanying drawings.

Referring to FIG. 22, the controller 180 outputs an audio (S500).

While outputting the audio, the controller 180 senses an object approaching the audio output module 152 as discussed above (S510). Step S510 is identical (or similar) to step S110 in the first embodiment or other steps in the other embodiments, and the detailed descriptions will be omitted.

However, in the fourth embodiment, the mobile terminal 100 includes the proximity sensor 141 so that the controller 180 may sense an object approaching the audio output module 152 through the proximity sensor 141.

The controller 180 may control characteristics of outputting the audio depending on the degree in which the object approaches the audio output module 152 (S520).

FIG. 23 is a view illustrating an example of the degree of approach.

In FIG. 23, it is assumed that the controller 180 may start to sense an object when the distance between the object and the audio output module 152 is L4. As the object reaches distances L4, L3, L2, and L1, the controller 180 may obtain the appropriate approach degree of the object approaching the audio output module 152.

Further, if the object reaches distance L0, the controller 180 may recognize that the object is fully brought in contact with the audio output module 152.

Characteristic(s) of outputting the audio may include at least one of an output volume of the audio and a replay speed of the audio.

For example, the controller 180 may change at least one of an output volume of the audio and a replay speed of the audio depending on the approach degree of the object approaching the audio output module 152.

As an example, as the object comes close to the audio output module 152, the controller 180 may increase at least one of the output volume of the audio and the replay speed of the audio. On the contrary, as the object becomes more distant from the audio output module 152, the controller 180 may decrease at least one of the output volume of the audio and the replay speed of the audio.

In a case where only the output volume of the audio is controlled by the controller 180 according to the degree of approach of the object, the controller 180 may gradually decrease the output volume of the audio as the object approaches the audio output module 152. Then, if the object is fully brought in contact with the audio output module 152 (that is, when the object reaches distance L0 in FIG. 23), the controller 180 does not output the audio.

As in the first embodiment, in the other embodiments, the controller 180 may pause or mute the audio not to output the audio.

As another example, as the object comes closer to the audio output module 152, the controller 180 may decrease at least one of the output volume of the audio and the replay speed of the audio. On the contrary, as the object becomes more distant from the audio output module 152, the controller 180 may increase at least one of the output volume of the audio and the replay speed of the audio.

Further, as the object approaches the audio output module 152, the controller 180 may decrease the output volume of the audio while increasing the replay speed of the audio.

Further, as the object approaches the audio output module 152, the controller 180 may increase the output volume of the audio while decreasing the replay speed of the audio.

FIGS. 24 to 26 are graphs illustrating various methods of the controller 180 controlling the output characteristics depending on the degree of approach.

In FIGS. 24 to 26, the horizontal axis refers to the approach degree of the object approaching the audio output module 152 and the vertical axis refers to output characteristics of the audio.

The percentages representing the levels of the output characteristics of the audio marked in the vertical axis may be regarding the maximum values of the audio output characteristics provided by the mobile terminal 100. For example, in a case where the output volume of an audio provided by the mobile terminal 100 ranges from 0 to 50, ‘100%’ marked in the vertical axis in FIG. 24 may mean that the output volume is 50, whereas 50% means the output volume is 25.

As a variation, the percentages may also be regarding values outputted before the controller 180 senses the object approaching the audio output module 152. For example, in a case where the output volume of the audio is 30 before a user brings his finger (or other object) close to the audio output module 152, “100%” marked in the vertical axis in FIG. 24 may mean the output volume of 30.

The controller 180 may discretely control the output characteristics according to the degree of approach. FIG. 24 is a graph illustrating an example of discretely controlling the output characteristics according to the degree of approach.

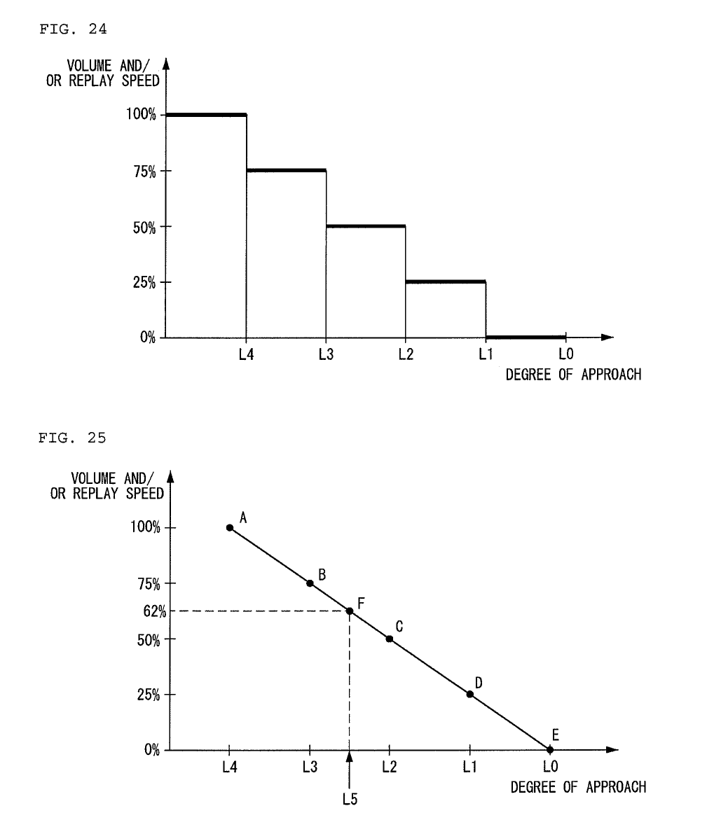

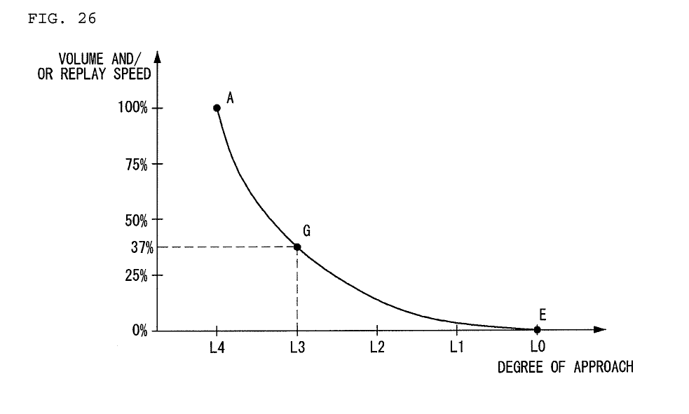

In FIG. 24, for example, in a case where the object is located within a region between L4 and L3 (e.g., in the example of FIG. 23), the controller 180 may control the output characteristics to be 75% such that the audio is output at 75% of the output volume and/or replay speed through the audio output module 152. If the object is located within a region between L3 and L2, the controller 180 may control the output characteristics to be 50% such that the audio is output at 50% of the output volume and/or replay speed through the audio output module 152. Further, if the object approaches up to a region between L2 and L1, the controller 180 may control the output characteristics to be at 25% of the output volume and/or replay speed through the audio output module 152. And, if the object approaches up to a region between L1 and L0 (L0 means the object contacts the audio output module 152), the controller 180 may control the output characteristics to be at 0% of the output volume and/or replay speed through the audio output module 152. In the example of FIG. 24, the user, administrator, mobile terminal or other entity can decide how the output characteristics may be controlled when the degree of approach is at L4, L3, L2 and L1. For example, depending on the configuration set as desired, if the degree of approach is at L3, then the output volume and/or replay speed may be output at %75 or %50 (without being duplicatedly used). This concept can be applied also to FIGS. 25 and 26.

In another example, the controller 180 may continuously control the output characteristics according to the degree of approach.

FIGS. 25 and 26 are graphs illustrating different examples of continuously controlling the output characteristics according to the degree of approach. In particular, FIG. 25 depicts a case where the output characteristics are linearly and continuously controlled and FIG. 26 depicts a case where the output characteristics are non-linearly and continuously controlled.

Points A, B, C, D, and E marked in FIG. 25 correspond to levels L4, L3, L2, L1, and L0, respectively. Further, Points A, G, and E marked in FIG. 26 correspond to levels L4, L3, and L0, respectively.

In FIG. 25, for example, in a case where the object reaches L5 which is located between levels L3 and L2, the controller 180 may control the output characteristics (e.g., volume and/or replay speed) to be 62% of the maximum value according to the graph.

In another case of FIG. 26, for example, in a case where the object reaches level L3, the controller 180 may control the output characteristics (e.g., volume and/or replay speed) to be 37% of the maximum value according to the graph. FIGS. 24-26 are mere examples and the invention encompasses other examples and variations. For instance, in these examples, while the volume may decrease discreetly or continuously, the replay speed may increase discreetly or continuously, or vice versa.

According to an embodiment, other examples of the output characteristics may be controlled. Further, after the volume or other output characteristics have changed, this change may be reverted back to the original position under a certain condition, e.g., if the object approaches the audio output module 152 again or after a predetermined time duration has elapsed. In one example, once the audio has been muted due to the approach of the object (which includes the contact by the object), then after a predetermined time has elapsed or when the object approaches the audio output module 152 again, the audio may be output once more through the audio output module 152. This re-outputting may occur instantaneously or gradually (e.g., the volume increases from 0% to 100% instantaneously or gradually). Further, this re-outputting may occur at a level that corresponds to the re-approach level. For example in FIG. 24, if the first approach was within the region L2 and L1, then the audio volume and/or reply speed is controlled to be output at the level of 25%. Then if the approach is made again (re-approach) within the region L4 and L3, then the audio volume and/or replay speed is changed from 25% to 75%. As a result, using the multiple approaches, the output characteristics can be variably controlled.

According to the invention, the various examples and embodiments may also be combined. Further, if appropriate, one or more features from one embodiment or example may be added to or replace one or more features in another embodiment or example.

The method of controlling the mobile terminal according to various embodiments can be written as computer programs and can be implemented in digital computers that execute the programs using a computer readable recording medium.

The method of controlling the mobile terminal according to embodiments can be executed through software. The software can include code segments that perform required tasks. Programs or code segments can also be stored in a processor readable medium and transmitted.

The computer readable recording medium includes all types of recording devices storing data readable by computer systems. Examples of the computer readable recording medium include ROM, RAM, CD-ROM, DVD±ROM, DVD-RAM, magnetic tapes, optical disks, floppy disks, hard disks, and optical data storage devices. The computer readable recording medium can also be distributed over network coupled computer systems so that the computer readable code is stored and executed in a distributed fashion.

While this document has been particularly shown and described with reference to exemplary embodiments thereof, it will be understood by those of ordinary skill in the art that various changes in form and details may be made therein without departing from the spirit and scope as defined by the following claims.

What is claimed is:

1. A mobile terminal comprising:
an audio output module configured to output an audio;
a sensing unit arranged to sense an object approaching the audio output module; and
a controller configured to stop the outputting of the audio, when the sensing unit senses the object approaching the audio output module while the audio is being output through the audio output module.

2. The mobile terminal of claim 1, wherein the sensing unit is either a touch device arranged to be near or at the audio output module, or a proximity sensor arranged at a location corresponding to the audio output module.

3. The mobile terminal of claim 2, wherein the sensing unit is the touch device, and the controller is configured to stop the outputting of the audio in response to a touch of a predetermined area near or at the touch device while the audio is being output; or
wherein the sensing unit is the proximity sensor, and the controller is configured to stop the outputting of the audio in response to a signal received from the proximity sensor notifying that a distance between the object and the audio output module is not more than a predetermined reference value while the audio is being output.

4. The mobile terminal of claim 1, further comprising:
a communication unit configured to provide a call receipt function,
wherein the audio, which is stopped from being output by the controller when the sensing unit senses the object approaching the audio output module, is one notifying the receipt of the call that is received through the communication unit.

5. The mobile terminal of claim 1, wherein the controller stops the outputting of the audio by pausing or muting the audio.

6. The mobile terminal of claim 1, wherein the controller is further configured to re-output the audio through the audio output module, when the sensing unit senses that the object is moved away and is no longer at a predetermined distance range of the audio output module.

7. A mobile terminal comprising:
an audio output module configured to output an audio;
a sensing unit arranged to sense an object approaching the audio output module; and
a controller configured to output a first sound source and a second sound source through the audio output module, and stop the outputting of at least one of the first and second output sources when the sensing unit senses the object approaching the audio output module while the first and second sound sources are being output through the audio output module simultaneously.

8. The mobile terminal of claim 7, wherein the sensing unit is either a touch device arranged to be near or at the audio output module, or a proximity sensor arranged at a location corresponding to the audio output module.

9. The mobile terminal of claim 8, wherein the sensing unit is the touch device, and the controller is configured to stop the outputting of the at least one of the first and second sound sources in response to a touch of a predetermined area near or at the touch device; or
wherein the sensing unit is the proximity sensor, and the controller is configured to stop the outputting of the at least one of the first and second sound sources in response to a signal received from the proximity sensor notifying that a distance between the object and the audio output module is not more than a predetermined reference value.

10. The mobile terminal of claim 7, wherein the audio output module outputs the first sound source, and then outputs the second sound source while the first sound source is being output, and
the controller stops the outputting of the second sound source while continuously outputting the first sound source, when the sensing unit senses the object approaching the audio output module.

11. A mobile terminal comprising:
an audio output module configured to output an audio;
a proximity sensor arranged to sense an object approaching the audio output module; and
a controller configured to control an output characteristic of the audio being output depending on an approach degree of the object approaching the audio output module, when the proximity sensor senses the object approaching the audio output module while the audio is being output through the audio output module.

12. The mobile terminal of claim 11, wherein the audio output characteristic includes at least one of an output volume of the audio and a replay speed of the audio.

13. The mobile terminal of claim 12, wherein the controller is configured to change in one direction at least one of the output volume and the replay speed as the object approaches the audio output module within a predetermined distance of the audio output module, and to change in another direction at least one of the output volume and the replay speed as the object becomes distant from the audio output module and is no longer within the predetermined distance of the audio output module.

14. A method of controlling a mobile terminal including an audio output module, the method comprising:
outputting an audio through the audio output module; and
stopping the outputting of the audio upon sensing an object approaching the audio output module.

15. The method of claim 14, wherein the stopping of the outputting of the audio includes one of pausing the audio and muting the audio.

16. The method of claim 14, further comprising:
receiving a call by the mobile terminal,
wherein the outputting step outputs the audio which notifies the receipt of the call, and
the stopping step stops the outputting of the audio notifying the receipt of the call upon sensing the object approaching the audio output module.

17. A method of controlling a mobile terminal including an audio output module, the method comprising:
outputting a plurality of different sound sources through the audio output module; and
stopping the outputting of at least one of the plurality of different sound sources, when an object approaching the audio output module is sensed while the plurality of sound sources are being output simultaneously.

18. The method of claim 17, wherein the plurality of different sound sources include first and second sound sources,
wherein the outputting step includes outputting the first sound source, and then outputting the second sound source while the first sound source is being output, and
wherein the stopping step stops the outputting of the second sound source while continuously outputting the first sound source, when the object approaching the audio output module is sensed.

19. A method of controlling a mobile terminal including an audio output module, the method comprising:
outputting an audio through the audio output module;
sensing an object approaching the audio output module; and
controlling an output characteristic of the audio being output depending on an approach degree of the object approaching the audio output module.

20. The method of claim 19, wherein the output characteristic includes at least one of an output volume of the audio and a replay speed of the audio.
